(19) United States
(12) Patent Application Publication
(10) Pub. No.: US 2010/0078944 A1
(43) Pub. Date: Apr. 1, 2010

(54) DOOR OPENER UNIT WITH A NOVEL PIVOT LATCH

(75) Inventor: Oliver Hirschoff, Mestetten (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: ASSA ABLOY Sicherheitstechnik GmbH, Albstadt (DE)

(21) Appl. No.: 12/238,629

(22) Filed: Sep. 26, 2008

(51) Int. Cl. E05C 3/12

(52) U.S. Cl. 292/198

(57) ABSTRACT

The invention relates to a door opener unit, comprising a receiving space for a latch of a door lock, a pivot latch with a locking block which locks or releases the latch in a defined manner in a door opening direction, and a latch guide surface along which the latch slides during the opening of the door until exiting from the receiving space. It is provided in accordance with the invention that the locking block of the pivot latch is arranged in a trapezoid manner with respect to its outline and the latch guide surface comprises a recess in which said trapezoid locking block can enter during the opening of the door.

### FIELD OF THE INVENTION

The present invention relates to a door opener unit as is used especially for buildings as well as for windows in buildings and the like.

### BACKGROUND OF THE INVENTION

ANSI door locks (ANSI=American National Standard Institute) are mainly used in the USA, Canada and also many other Asian countries which obviously can also be purchased in Europe. The two most important types of these ANSI door locks are mortise locks and cylindrical locks. In the case of a mortise lock, the entire door lock is inserted from the edge of the door into a prepared recess in the door leaf. In the case of cylindrical locks, however, two bores are made in the door leaf which usually stand perpendicular with respect to each other: a larger one from the front side and a smaller transverse bore from the edge of the door, in which the cylindrical lock and an actuating mechanism are inserted.

In many cases it is desirable to additionally arrest an especially spring-loaded latch in its closing position, i.e. during the engagement of the latch in a corresponding recess of a strike-plate or in the receiving space of a corresponding door opener, so that the latch cannot be moved by manipulative insertion of an object into the gap of the door and especially cannot be pushed back or pressed into the door lock. Such protection from breaking in is known as a latch blocking device or latch blocking function. In the case of a cylindrical lock, this is usually realized by a baffle pin which is located on the rear side of the latch and which locks the latch in the pressed position and leaves the latch in a resilient state in a non-pressed position, as described for example in U.S. Pat. No. 2,723,873. In the case of a mortise lock, this is usually realized by a so-called additional auxiliary or locking latch which is mostly arranged adjacent to the latch, as is known for example from EP 1 031 686 A2. The latch is only movable when the baffle pin is not pressed or the locking latch is not pressed, and it can be pushed back or pressed into the door lock.

In order to cover the widely available variants of both types of door locks (cylindrical lock and mortise lock), strike-plates with intermediate elements were offered on the market, which in combination with a door opener form a ready-to-install door opener unit. The disadvantageous aspect in the solutions known from the state of the art is a relatively large countersunk portion on the case surface which is required for installation. This leads to a high amount of work for installation and mounting and is visually not satisfactory. As a result of the large countersunk portion on the case surface there is also an adverse effect on fire, heat, noise and burglary protection. For solving this problem, a substantially plane strike-plate with oblique sliding portions protruding into the receiving space has been proposed and filed for patent.

### SUMMARY OF THE INVENTION

It is the object of the present invention to provide a functionally improved door locking unit which especially allows smooth opening of the door and ensures at the same time a high degree of protection against break-ins.

This object is achieved by a door opener unit with the features of claim 1. Advantageous further developments are the subject of the dependent claims.

The door closing unit in accordance with the invention comprises a receiving space for the latch of a door lock and a pivot latch with a locking hook which defines the latch in one direction of door opening, i.e. it controls, locks or releases the same. The door closing unit in accordance with the invention further comprises a latch guide surface (or oblique sliding portion) on which the latch can slide along the same or off the same during the opening of the door until leaving the receiving space and is preferably pressed back or inwardly against the force of a spring into the door lock.

It is provided in accordance with the invention that the locking hook of the pivot latch is arranged in a trapezoid manner with respect to its outside shape or contour (outline). In other words: a shadow surface of the locking hook in the direction of door opening has a trapezoid shape. Moreover, the latch guide surface comprises a recess in which said trapezoid locking hook can immerse during the opening of the door.

In order to open the closed door, the pivot latch is usually released in a remote-controlled way (electric unlocking), whereupon the locking hook can be pivoted away in the direction of the opening of the door, which is also called twisting open. Said pivoting motion is initiated by a pulling force or pressing force on the door. The trapezoid locking hook finally enters the recess in the latch guide surface and thus quasi closes said recess in the latch guide surface substantially, thus providing a relatively large latch guide surface. During a continued opening motion of the door, the latch slides on said large latch guide surface and is pushed back or pressed into the door lock. As a result there is an exceptionally friction-free and smooth running of the latch on the latch guide surface until the exit from the receiving opening of the door closing unit. This is also noticeable in a reduced development of noise.

In order to ensure secure guidance or secure sliding of the latch on the latch guide surface during the opening of the door (which is a precondition for a smooth opening motion), the latch must not engage in any case in the recess in the latch guide surface. In the case of such an engagement or gripping, the latch could jam or chock on the front edge of said recess. In order to prevent this, it needs to be ensured that the latch in all imaginable installation variants can always slide directly on the latch guide surface when the door opener latch is pivoted open. This is the case when the locking hook and thus also the recess in the latch guide surface is narrower than the width of the latch (the details of “narrow” and “wide” relate to a length transversally to the door opening direction). On the other hand, the locking hook must obviously be arranged in a stable way. In order to provide a narrow but still stable locking hook, a trapezoid shape is proposed for the same, i.e. the tip or the upper edge of the locking hook is narrower or provided with a smaller length than the base region of the locking hook with which the locking hook is arranged in the pivot latch. This leads to a trapezoid outline or trapezoid shape of the locking hook. As a result of this trapezoid shape, a substantially even or constant progression of tension is obtained in the case of loading of the locking hook (as a result of massive action of force for example) over the height of the locking hook (the height extends from the base area to the tip or upper edge), specially concerning material tension caused by a bending moment.

It is preferably provided that the trapezoid shape of the locking hook corresponds to an isosceles trapezium, i.e. the legs of the trapezium or oblique edges (flanks) extending from the tip of the locking hook to the base area are arranged in a mirror-symmetrical way with respect to a central line.

It is preferably provided that the recess in the latch guide surface is also arranged in a trapezoid manner and especially has the same trapezoid shape of the locking hook, but enlarged to scale. When the locking hook enters said recess, an air gap, preferably one with constant width (or constant distance), is obtained between the outline of the locking hook and the shape of the recess. It is further preferable that the face surfaces of the legs of the trapezium (flanks) are applied in an angular way in the door opening direction over the thickness of the locking hook. As a result, the locking hook can then also enter the recess of the latch guide surface without canting when there is an only small dimension of the gap or stronger dirt accumulation.

The trapezoid locking hook is ideally arranged in one part, i.e. it is integral or materially connected with the pivot latch. The trapezoid locking hook can further be arranged on a base or base section. The construction especially in the foot or base region of the locking hook is preferably arranged in a tension-optimized manner, by large transitional radii for example.

The locking hook is preferably arranged over its entire height, i.e. from the base region to the tip or upper edge, substantially with a constant thickness. This can include the base area.

It is further preferable that the locking hook is provided with a rounded section over its thickness at its tip or upper edge. This enables on the one hand canting-free entry of the locking hook into the recess in the latch guide surface and improves on the other hand the control of a baffle pin of a latch locking device. The rounding is especially arranged in the cross section as a quadrant, with the rounding substantially facing in the door opening direction.

According to a preferred further development it is provided that the door opener unit in accordance with the invention comprises at least one door opener with the pivot latch, a strike-plate with at least one recess for the engagement of the latch and an intermediate element which is arranged between the strike-plate and the door opener. It is provided in this respect that the latch guide surface with the recess is arranged in the intermediate element.

Said intermediate element is preferably arranged as a component made of one piece or of integral configuration. The intermediate element is can be arranged as a metal part, e.g. as a sheet-metal-formed part, forged part, precision-cast part or pressure-die-casting part. The intermediate element can also be arranged as a plastic part, e.g. a plastic injected molded part.

It is further preferable that the receiving space for the latch is adjacent to at least one auxiliary receiving space for a locking latch or auxiliary latch of the door lock. The auxiliary receiving space is located laterally to the receiving space for the latch, with said lateral direction being a transverse direction, and preferably a vertical transverse direction, to the door opening direction. Said auxiliary receiving space is used for controlling a locking latch of a latch locking device, which shall be explained below in closer detail in connection with an embodiment. Preferably, said auxiliary receiving space in the door opening direction is delimited by a locking-latch guide surface, on which the locking latch can slide or slide off during the opening of the door until the exit from the auxiliary receiving space.

Separate protection is also claimed for the above further development in combination with the features of claim 1. Further developments thereof are obtained by combination with other features disclosed in this application insofar as no technical contradiction arises from the same.

Two auxiliary recesses are especially provided which extend on both sides of the receiving space for the latch and which thus leads to a substantially mirror-symmetrical arrangement of the door opener unit in accordance with the invention. The door opener unit in accordance with the invention can thus be used both for right-hand doors as well as for left-hand doors, or for doors turning inwardly or outwardly. The door opener unit merely needs to be turned for installation in the one or other use. The door opener unit in accordance with the invention can similarly also be used for double-wing doors.

A strike-plate is preferable for the further development as described above which in addition to a central recess for the lead-through of a latch comprises at least one auxiliary recess, preferably two auxiliary recesses, for the lead-through of the locking latch. Ideally, the recesses are joined into a common recess.

It is also preferable that the latch guide surface and the locking-latch guide surface are arranged as a common plane surface which is preferably arranged in the intermediate element.

In particular, said common surface is arranged in an inclined way relative to the direction of engagement of the latch, with an angle of larger than 0° or smaller than or equal to 45°. Such a surface inclination can also only be provided for the latch guide surface or only for the locking-latch guide surface.

The door opener unit is provided especially for the use with mortise door locks without a latch locking device and especially for use with mortise door locks with a latch locking device (for example with at least one locking latch of the kind mentioned above).

Preferably, the door closing unit in accordance with the invention is mounted in a door frame or the like. Within the scope of the invention, the door closing unit in accordance with the invention can also be arranged in the door leaf or the like.

A preferred embodiment of the invention will be explained below by reference to the drawings, wherein:

### BRIEF DESCRIPTION OF THE DRAWINGS

FIG. 1 shows an embodiment of the door opener unit in accordance with the invention in a perspective view;

FIG. 2 shows the door opener unit in accordance with the invention in an exploded view;

FIG. 3 shows the door opener unit in accordance with the invention in a top view with a view of the strike-plate;

FIG. 4 shows the door opener unit in accordance with the invention in a side view with a view against the door opening direction.

### DETAILED DESCRIPTION OF THE DRAWINGS

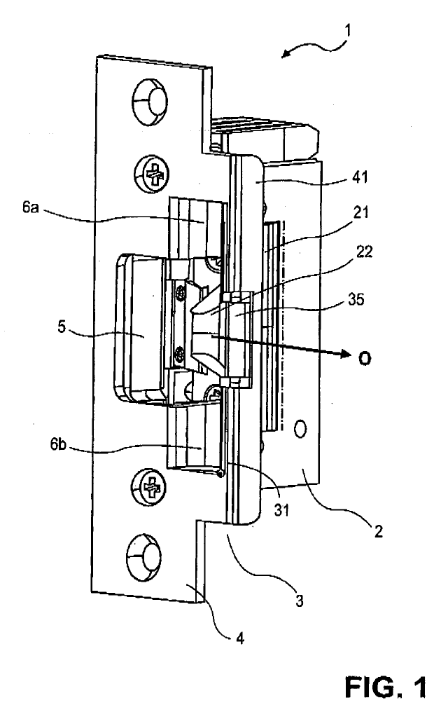

FIG. 1 shows a perspective view of an embodiment of the door opener unit designated with reference numeral 1. Door opener unit 1 comprises a door opener 2 and a strike-plate 4 as well as an intermediate element 3 arranged between the strike-plate 4 and the door opener 2, which is shown in this illustration only within limits. Door opener 2 comprises a pivot latch or a pivot latch device 21 with a trapezoid locking hook 22. The direction of door opening is shown with the arrow O. The door closing direction is the direction opposite of this. Door opener unit 1 comprises a receiving space 5 for the engagement of a respective latch of a door lock. The receiving space 5 is extended transversally to the door opening direction O on two sides by auxiliary receiving spaces 6a and 6b which are used for the engagement and control of a locking latch or auxiliary latch of the door lock. Concerning a preferred installation position of the door closing unit 1, the auxiliary receiving spaces 6a and 6b are arranged above and below the receiving space 5.

The strike-plate 4 comprises a short oblique inlet section 41 on which the latch and even a locking latch will slide during the closing of the door and are pressed back or into the door lock until the same can deflect into the receiving space 5, through which the door is locked. Only a countersunk portion for said oblique inlet section 41 is required on the frame surface for the installation of a door closing unit 1 into a door frame (visual side of the frame), thus reducing the installation work as compared with other solutions. After the installation, merely the oblique inlet section 41 is visible and accessible on the frame surface, which further improves fire, heat and sound protection and security against break-ins as compared with known solutions. The door opener unit 1 further comprises a groove 35 originating from the receiving space 5 in the door opening direction O, which groove is used for controlling the baffle pin of the door lock. Based on the auxiliary receiving spaces 6a and 6b and the groove 35, the door opener unit 1 is similarly suitable for cylindrical locks and mortise lock, both with and without latch locking device. The widely used variants of both door locks (cylindrical lock and mortise lock) can thus be combined with this door closing unit 1.

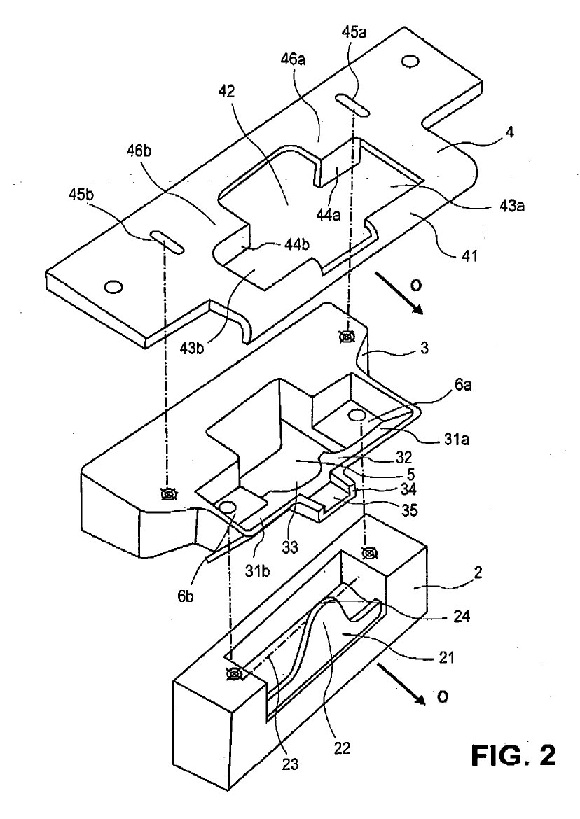

FIG. 2 shows the substantial modules of the door opener unit 1 in accordance with the invention in an exploded view. The intermediate element 3 is screwed onto the door opener 2 and the strike-plate 4 onto the intermediate element 3 (the respective connecting screws are not shown). Door opener 2 comprises the pivot latch 21 with the integrally arranged trapezoid locking hook 22 which can tightly hold or block the latch received in the receiving space 5 in the door opening direction O. If forces are applied against the closed door in the door opening direction O, the latch received in the receiving space 5 will exert a bending moment on the locking hook 22, causing material tensions in the locking hook. As a result of the trapezoid shape of the locking hook 22, the caused material tensions are substantially constant over the height of the locking hook 22. The locking hook 22 has an upper edge or tip 24 which delimits or ends the height of locking hook 22. In the illustrated position, the trapezoid locking hook 22 is in the blocked or locked position. The release of the pivot latch 21 occurs by a remote-controllable mechanism (not shown) in the interior of door opener 2. The pivot latch 21 in door opener 2 is pivotably held about a pivoting axis 23, as a result of which the trapezoid locking hook 22 can pivot or flip away after the release of the pivot latch 21 in the door opening direction O (so-called twisting open) in order to release the latch in the door opening direction O.

The intermediate element 3 is made integrally and forms the relevant part of the receiving space 5 for the latch. The receiving space 5 comprises adjacent auxiliary receiving spaces 6a and 6b transversally to the direction of door opening O, spaces are used for controlling a locking latch. As a result of the mirror-symmetrical arrangement of the auxiliary receiving spaces 6a and 6b on both sides, the door opener unit 1 in accordance with the invention can be used for right-hand and left-hand doors. The door opener unit 1 merely needs to be turned by 180° for installation in the door frame. In the door opening direction O, locking-latch guide surfaces 31a and 31b are present in the area of the auxiliary receiving spaces 6a and 6b which together with the latch guide surface 32 are arranged as a common surface. The latch guide surface 32 comprises a trapezoid recess 33 in which the trapezoid locking block 22 of door opener 2 can enter when turning open in the door opening direction O. Starting from the receiving space 5, a nose 34 with a groove 35 for controlling a baffle pin of the door lock is located in the middle at the upper end of the latch guide surface 32.

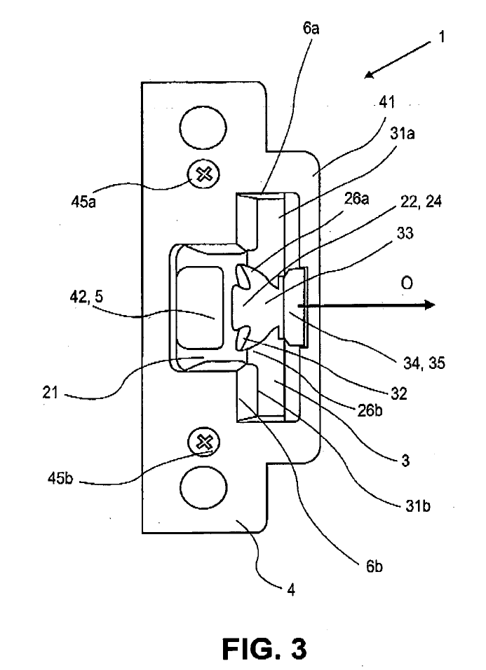

The strike plate 4 is arranged as a sheet-metal formed part (alternatively as a precision-cast part or die cast part) and comprises a central receiving opening or recess 42 which transversally to the door opening direction O converges into auxiliary receiving openings or auxiliary recesses 43a and 43b. The receiving openings 42, 43a and 43b are closed in the door opening direction O by a transverse web or connecting web which is arranged in a curved way and is simultaneously the locking-latch guide surface 41, which facilitates pushing back the latch or locking latch into the door lock when closing the door. In the middle of this transverse web, a recess for the nose 34 of the intermediate element 3 (which is shown very clearly in FIG. 3, as explained below) is located. At the rear ends (with respect to the door opening direction O) of the auxiliary recesses 43a and 43b, the strike-plate 4 comprises a tongue 44a and 44b which in the mounted state of the strike-plate 4 protrude into the auxiliary spaces 6a and 6b, respectively, of the intermediate element 3 and are used for controlling an auxiliary latch of the door lock. The strike-plate 4 further comprises two oblong holes 45a and 45b through which an adjustable fastening may occur on the intermediate element 3.

The function of the door opener unit 1 in accordance with the invention with a door lock with a locking latch (mortise lock) will be explained below: In the closed state of the door, the latch of the door lock penetrates the central recess 42 of the strike-plate 4 and engages in the receiving space 5 of the intermediate element 3. In the door opening direction O, the latch is tightly held or blocked by the trapezoid locking block 22 of the pivoting latch 21. At the same time, the locking latch of the door lock rests on the strike-plate 4 in the area of 46a and 46b and is thus in a pressed arrested position, so that the latch cannot be pushed back or pressed into the door lock, which thus makes a manipulative opening attempt more difficult (the latch is only movable when the locking latch is not pressed). The release of the pivot latch 21 occurs by a remote-controlled opening signal (electric unlocking), whereupon the trapezoid locking block 22 can swivel away or turn open in the door opening direction P. The required forces are provided by an opening motion of the door. The latch can thereupon be moved within the recess 5 in the opening direction O, with the locking latch being able to deflect subject to spring force through the auxiliary receiving opening 43a and 43b into the auxiliary receiving space 6a and 6b, through which the arrest for the latch is released. In the further course of the opening movement of the door opening direction O, the locking block 22 of the pivot latch 21 enters the recess 33 in the latch guide surface 32 in the intermediate element 3, whereupon the latch and the locking latch of the door lock can slide off the latch guide surface 32 and the locking-latch guide surface 31a and 31b, and are slid or pressed into the door lock in a substantially simultaneous way until the door is finally released. In order to enable smooth opening of the door, it is ensured in accordance with the invention that the latch of the door lock is able to slide in all possible mounting positions always directly on the latch guide surface 32 of the intermediate element 3 when the locking block 22 is pivoted open, or is able to slide off on the same. This is given in accordance with the invention in such a way that the locking block 22 of the pivot latch 21 can enter a corresponding recess 33 in the latch guide surface 32 and that the width of the locking block (or its length transversally to the door opening direction O) and thus also the width of the recess 33 is narrower than the width of the latch. It is thus prevented especially that the latch will slide along the front milling edge (the milling edge facing the receiving space 5) of the recess 33 and can get jammed or hooked into the same. In order to ensure the highest possible strength of the locking block 22, the approach of a constant distribution of tension (over the height) is chosen which thus leads to the trapezoid shape as already explained above.

The closing of the door occurs in a reverse sequence. The required forces are provided by a closing motion of the door (door closing direction against the direction of arrow O). After the opening process as described above, the pivot latch 21 springs back to the blocking position together with the locking block 22. The locking process is initiated in such a way that the latch and locking latch of the door lock slide off on the oblique inlet section 41 of the strike-plate 4 and are thus pressed into the door lock. Finally, the latch can engage in the receiving space 5 of the intermediate element 3 by passing over the upper rounded edge of the locking block 22. At the same time, the locking block engages in the auxiliary receiving space 6a and 6b. With continued closing motion, the locking latch slides off the tongue 44a and 44b of the strike-plate 4, and is thus pressed into the door lock, thus leading to the arresting of the locking latch. The locking latch finally comes to rest in the area 46a and 46b of the strike-plate and is held there in its arrested position.

The function of the door opener unit 1 in accordance with the invention will be explained by reference to a door lock with a baffle pin (cylindrical lock): In the closed state of the door, the latch of the door lock grasps through the central recess 42 of the strike-plate 4 and engages in the receiving space 5 of the intermediate element 3. At the same time, the baffle pin rests on the upper edge or the tip 24 of the locking block 22 and is thus located in a pressed position that arrests the latch. After the release of the pivot latch 21, the locking block 22 pivots away in the door opening direction O, through which the baffle pin can deflect and release the latch. In the further course of the opening movement, the latch slides together with the baffle pin on the latch guide surface 32 and is pressed simultaneously with the baffle pin into the door lock. In the further course of the opening movement, the groove 35 in the nose 34 is used for guidance of the baffle pin in order to prevent that the baffle pin can hook into the strike-plate 4 (i.e. on the transversal web) at the front inside edge of the recess 42 before the latch has left the recess 5 completely.

The closing motion for a door lock with baffle pin occurs accordingly in reverse sequence.

FIG. 3 shows the door opener unit 1 in accordance with the invention in a top view with a front view of strike-plate 4. This direction of the view corresponds to the engagement direction of the latch. This illustration clearly shows the central receiving opening 42, beneath which the receiving space 5 is located. The auxiliary receiving spaces 6a and 6b are situated adjacent to the receiving space 5 transversally to the door opening direction O. The latch guide surface 32 with the trapezoid recess 33 for the locking block 22 of the pivot latch 21 is also shown very clearly. The latch guide surface 32 is arranged as a common surface with the locking latch guide surfaces 31a and 31b. The inclination of these common surfaces is approximately 45°, relating to the direction of engagement of the latch. Other angular values of larger than 0° to 45° are possible. The illustration also clearly shows the trapezoid locking block 22, of which the top edge 24 is shown in this top view, and the legs of the trapezium or the oblique flanks 26a and 26b (which cause the trapezoid shape) extending downwardly (to the base of the locking block). The visible face surfaces of the legs 26a and 26b of the trapezium are aligned in an angular manner over the thickness of the locking block 22 in the door opener direction O in order to ensure the entry of the locking block 22 into the recess 33 even under difficult conditions. In the illustrated position, the locking block 22 is in the locking position in which it would lock a latch of a door lock situated to the left of it in the receiving space 5 in the door opener direction O and would thus lock the door. A trapezoid recess 33 is visible in the latch guide surface 32 to the right of the locking block 22. The trapezoid locking block 22, when turned open, can enter said trapezoid recess 33 in the door opener direction O, with an air gap remaining between the outside contour of the locking block 22 and the inside contour of the recess 33 in order to prevent canting. A gap can further be recognized between the upper end of the latch guide surface 32 (or 31a and 31b) and the front inside edge of the recess 42 (on the transverse web), caused by the oblong holes 45a and 45b with which the strike-plate 4 is adjustable in its position relative to the intermediate element 3 and the door opener 2. This gap is bridged by the nose 34 (with the groove 35) of the intermediate element 3, thus preventing any canting of the latch and especially a baffle pin in said gap.

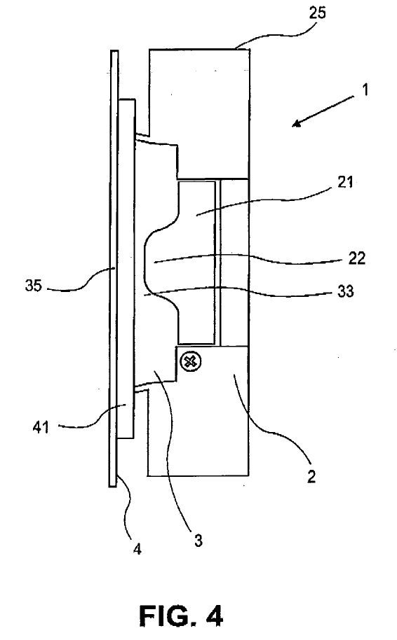

FIG. 4 shows the door opener unit 1 in accordance with the invention in a side view in direction against the door opening direction O. The strike-plate 4 is located in this illustration on the left, and the door opener 2 with an electric connection 25 on the right side. An intermediate element 25 is arranged between the strike-plate 4 and the door opener 2. This illustration clearly shows the trapezoid locking block 22 of the pivot latch 21 and the trapezoid recess 33 in the latch guide surface 32 in the intermediate element 3. The locking block 22 is located here in the locking position.

1. A door opener unit, comprising a receiving space for a latch of a door lock, a pivot latch with a locking block which locks or releases the latch in a defined manner in a door opening direction, and a latch guide surface along which the latch slides during the opening of the door until exiting from the receiving space, wherein the locking block of the pivot latch is arranged in a trapezoid manner with respect to its outline and the latch guide surface comprises a recess in which said locking block can enter during the opening of the door.

2. A door opener unit according to claim 1, wherein the recess in the latch guide surface is also arranged in a trapezoid manner and an air gap is given between the outline of the locking block and the contour of the recess during the entry of the locking block into said recess.

3. A door opener unit according to claim 1, wherein the locking block is arranged in an integral manner with the pivot latch.

4. A door opener unit according to claim 1, wherein the locking block is arranged with a substantially constant thickness over its entire height.

5. A door opener unit according to claim 1, wherein the locking block is rounded-off at its upper end.

6. A door opener unit according to claim 1, comprising a door opener with a pivot latch, a strike-plate with at least one recess for the engagement of the latch, and an intermediate element which is arranged between the strike-plate and the door opener, with the intermediate element comprising the latch guide surface with the recess.

7. A door opener unit according to claim 6, wherein the intermediate element is arranged in an integral way as a metal or plastic part.

8. A door opener unit according to claim 6, wherein at least one auxiliary receiving space for a locking latch of the door lock is situated adjacent to the receiving space for the latch transversally to the door opening direction, with said auxiliary receiving space being delimited in the door opening direction by a locking-latch guide surface, along which the locking latch slides during the opening of the door until exiting from said auxiliary receiving space.

9. A door opener unit according to claim 8, wherein the latch guide surface and the locking-latch guide surface are arranged as a common planar surface.

10. A door opener unit according to claim 9, wherein the common surface with respect to the engagement direction of the latch is arranged in an inclined way, having an angle of larger than 0° and smaller than or equal to 45°.
